(19) United States
(12) Patent Application Publication
(10) Pub. No.: US 2007/0170309 A1
(43) Pub. Date: Jul. 26, 2007

(54) Flight device (aircraft) with a lift-generating fuselage

(76) Inventor: Konrad Schafroth, Bern (CH)

Correspondence Address: BLANK ROME LLP, 600 NEW HAMPSHIRE AVENUE, N.W., WASHINGTON, DC, 20037, US

(21) Appl. No.: 11/263,949

(22) Filed: Nov. 2, 2005

Related U.S. Application Data
(63) Continuation of application No. PCT/EP04/50719, filed on May 5, 2004.

(30) Foreign Application Priority Data
May 5, 2003 (CH) 2003CH-00779

(51) Int. Cl. B64C 1/00

(52) U.S. Cl. 244/36

(57) ABSTRACT

An aircraft has a lift-generating fuselage (1), the largest span (11) of the fuselage being in the third fifth (15) or the four fifth (17) of the total length thereof. The outline of the fuselage progressively tapers off in the first fifth (13) and in the last fifth (18). The aircraft has two wings (2), the surface of the projection of said two wings in a horizontal plane representing less than thirty percent of the entire lift area, and the wings being located in said third fifth (15) or fourth fifth (17) of the total length of the fuselage. An elevator unit (4) is located on the last fifth (18) of the fuselage. The longitudinal central profile of the aircraft has a negative curvature, and the longitundal profile of the wings has a positive curvature. The form of the aircraft resembles the form of a fish.

The present invention concerns a new flight device, in particular a flight device characterized by a new shape.

Conventional flight devices have a cylinder-shaped fuselage for the passengers or the freight, a wing for the lift and an empennage (tail unit) for maintaining flight stability. The wings have a wide aspect ratio, which however has the disadvantage that large forces are generated through the considerable bending moments and that the wings accordingly have to be constructed massively. The useful volume of traditional flight devices is small relative to the outer dimensions and the wetted surface. The lift generated by larger wings is partially compensated by the additional weight.

So-called Flying Wings type aircraft have also been described, with a fuselage designed in such a fashion that it also generates lift. The empennage is done away with. It is even possible to go as far as to integrate the fuselage wholly in the wings in order to achieve better flight performance. Whereas with a tailed flight device, the flight performance is induced by the wing and the pitch control as well as the longitudinal stability by the empennage, a tailless flight device must achieve all three tasks with the wing. An essential part of the wing must take on these tasks and cannot be used for generating lift. A greater wing surface is therefore needed than for a tailed flight device.

Since Flying Wings type airplanes have only a short empennage lever arm, they are very sensitive to the position of the center of gravity. Because of the coupling of the parameters, they are difficult to design.

At high speeds, the wing of a flight device can be kept smaller. It is even possible to design the flight device's fuselage in such a manner that, at high speeds, the fuselage itself can generate the required lift. In this case, wings are no longer needed. Such flight devices are called lifting body. Because of the smaller aspect ratio of the lift surface, lifting bodies have the disadvantage that the induced drag at great angles of incidence can be very high. A further disadvantage of such a construction is that a high speed is needed for taking off and landing.

From the starting point of the prior art, it is thus the aim of the present invention to propose a flight device having a small aspect ratio, yet at the same time having good gliding characteristics.

It is a further aim of the present invention to achieve a good controllability.

It is a further aim of the present invention to achieve as good an efficiency as possible for the engine installation.

It is a further aim of the invention to achieve as good an efficiency as possible for the engine intake and the powering unit for the most important flight phases (taking off, climbing flight, cruising flight, etc.).

It is a further aim of the invention to prevent as far as possible the sucking in of outside objects into the engine during taking off and landing.

It is a further aim of the invention to build a flight device in which the added drag caused by the powering unit is reduced.

It is a further aim of the invention to design the aerodynamics and thus the shape of the flight device so that lots of space is available for fitting in the powering unit and for all systems and that the location of these installations is used to adapt the center of gravity.

It is a further aim of the present invention to reduce the operating costs in comparison with traditional flight devices.

It is a further aim of the present invention to increase the survival chances of the passengers in the case of an accident.

It is a further aim to reduce the noise emission of such flight devices.

It is a further aim of the present invention to increase the commercial traveling speed.

It is a further aim of the present invention to reduce the minimal speed and thus to diminish the taking off and landing speed of such a flight device.

It is a further aim of the present invention to achieve as good flight performances as possible, in particular when flying slowly.

It is a further aim of the present invention to reduce the trim drag over the whole speed range.

These aims are achieved by a flight device having the characteristics of the independent claims. Preferred embodiments are indicated in the dependent claims.

In particular, these aims are achieved through a flight device with a lift-generating fuselage, whose outline tapers progressively in the front fifth and in the rear fifth, with two wings, wherein the projection area of both wings on a horizontal plane represents less than forty percent of the total lift surface, with a horizontal stabilizer (tail unit) in the rear fifth of the fuselage,

wherein the longitudinal middle profile of the flight device has a negative cambering and wherein the longitudinal profile of the wings have a positive cambering.

With this arrangement, the fuselage (or the fuselage's skeleton outline) is slightly cambered downwards whilst the wings (or the wings' skeleton outline) is at least partly cambered upwards.

This has among others the advantage that the stability is increased, among others because the vortex do not burst asymmetrically over the wings.

The aerodynamically best possible distribution of the cross sections of the flight device along the longitudinal axis of the flight device could be achieved if the maximum span of the wings is between 50 to 60% of the fuselage length. This way, the center of pressure and the aerodynamic center and thus also the center of gravity lie relatively far in front, at about 39% of the fuselage length. This can cause problems with balancing the flight device, since the powering unit is placed behind the center of gravity. A further problem arises with the height of the main landing gear, since the latter is placed relatively close behind the center of gravity.

This problem is solved according to the invention in that the shape of the flight device is designed in such a way that the aerodynamic center/center of pressure and thus also the center of gravity comes to lie further behind. This increases the stability of the flight device.

According to the invention, the maximum span of the wings comes to lie between 60% and 80% of the length of the fuselage, preferably between 66% and 80%. This way, the center of pressure and thus also the center of gravity move towards the rear. Thus, the flight device can be balanced more easily, since then the powering unit comes to lie closer to the center of gravity. In this manner, there is more leeway for balancing the flight device when installing the systems and the powering unit. A further advantage of having the center of gravity lie far behind is the possibility that can arise from having a short main landing gear, which results in further advantages in weight and air drag.

The stability is also achieved according to the invention with a flight device with a lift-generating fuselage, having the largest span in the third and fourth fifth of the total length, and whose outline tapers progressively in the first fifth and in the last fifth and has wings. The projection area of both wings on a horizontal plane represents less than 40, preferably less than 30, in an even more preferred embodiment less than 20 percent of the projection on a horizontal plane of the total lift surface. The wings are located in the third and fourth fifth of the total length of said fuselage. The flight device has a horizontal stabilizer (tail unit) at the rear fifth of the fuselage, whose span preferably has at least 90% of the span in the third or fourth fifth of the fuselage.

The inventive flight device differentiates itself from known flight devices also through a new distribution of the lift surface along the longitudinal axis of traditional flight devices.

The ratio between the lift surface of the third and fourth fifth of the flight device including the wings and the lift surface of the first and second fifth of the flight device is preferably between 1.5 and 3.0, whilst the ratio between the lift surface of said third and fourth fifth of the flight device including the wings and the lift surface of the last fifth of the fuselage is between 5.0 and 15. The lift surface of the last fifth of the fuselage is however about the same size or even slightly smaller than the lift surface of the first fifth of the flight device.

This construction has the advantage that it can be very compact. Because of the small span that is made possible through the lift-generating fuselage and the small wings, the moments exerted on the structure are smaller than for traditional flight devices, so that the bearing structure can be lighter yet built in a stable manner.

This construction also has the advantage that the distribution of the cross sections of the flight device along the flight device's longitudinal axis is nearly optimal, allowing a higher commercial traveling speed in the transonic area.

In a preferred embodiment, the aerodynamics and thus the shape of the flight device are further designed in such a manner that the main landing gear can be made as short and light as possible.

The wings are small and horizontal or nearly horizontal. The projection surface of both wings in a vertical plane represents less than 60 percent of the projection surface of both wings on a horizontal plane. Since there is an empennage, such a flight device is easy to steer. Instead of through fins on the wings, control around the longitudinal axis is effected only through shifting the elevators in opposite direction.

The cockpit is preferably located in a bulb-like thickening of the fuselage's upper side, said thickening being as long as said fuselage. This has the consequence that the interference drag between the cockpit and the fuselage is minimized.

Hereafter, preferred embodiments of the object of the invention will be described with the aid of the figures, in which:

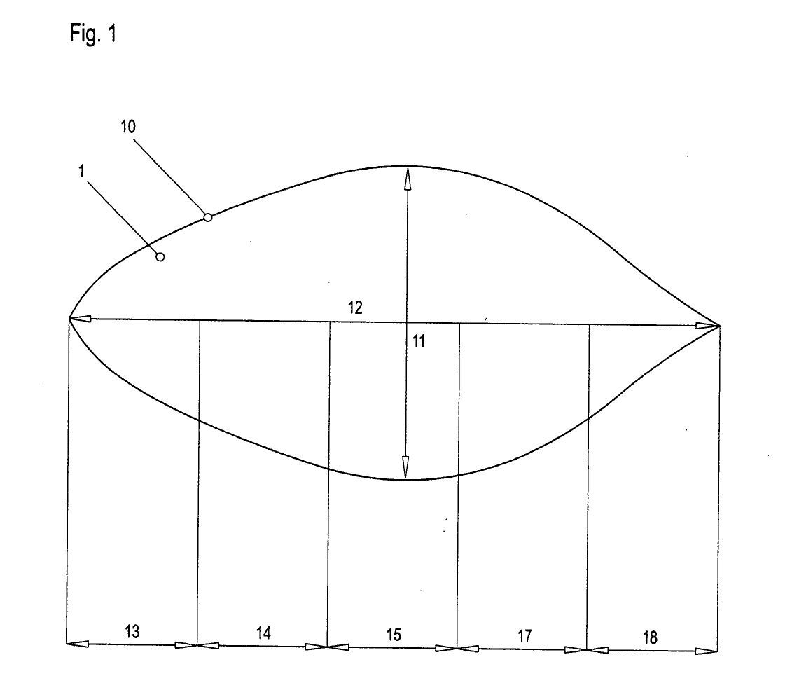

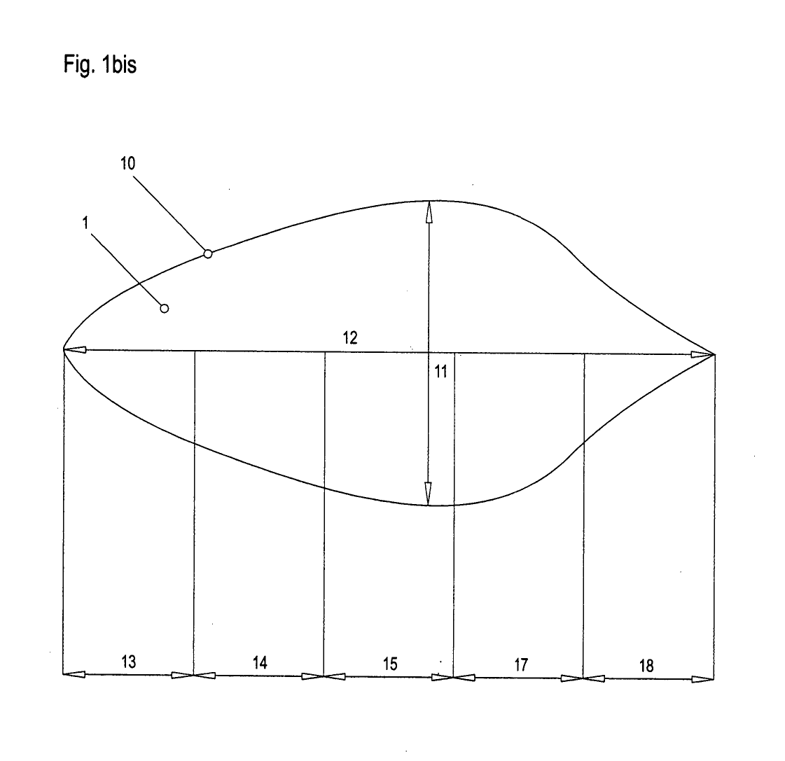

FIG. 1 shows the outline of the fuselage.

FIG. 1bis shows the outline of the fuselage in an alternative embodiment.

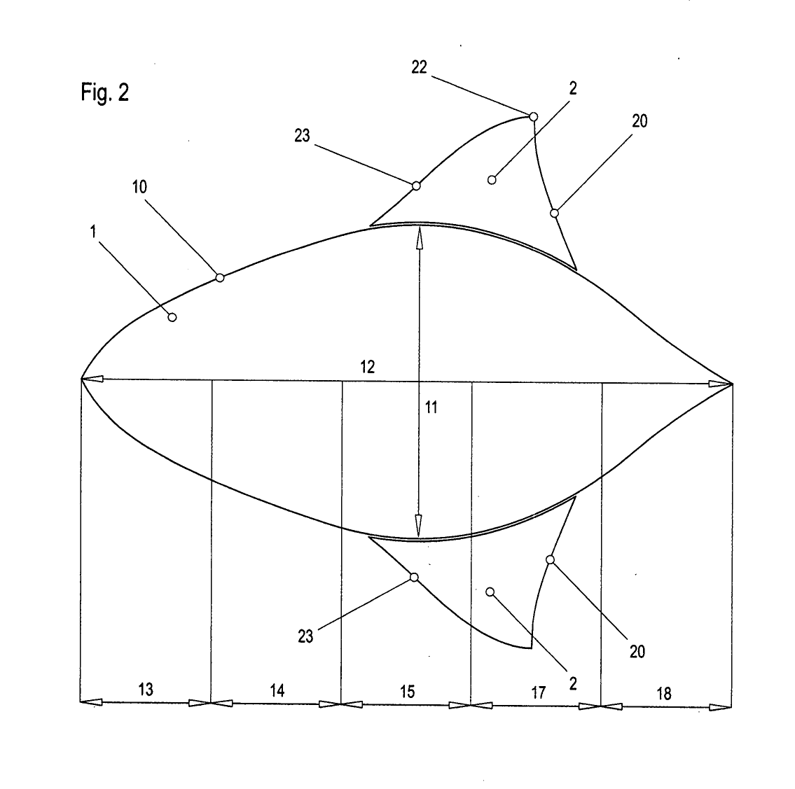

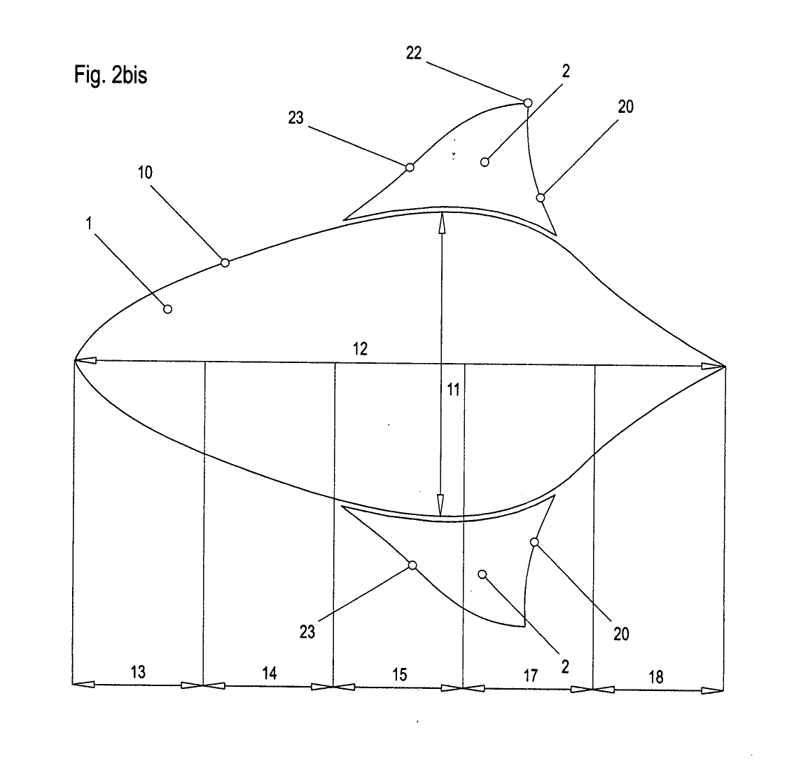

FIG. 2 shows the fuselage with the wings.

FIG. 2bis shows the fuselage with the wings in an alternative embodiment.

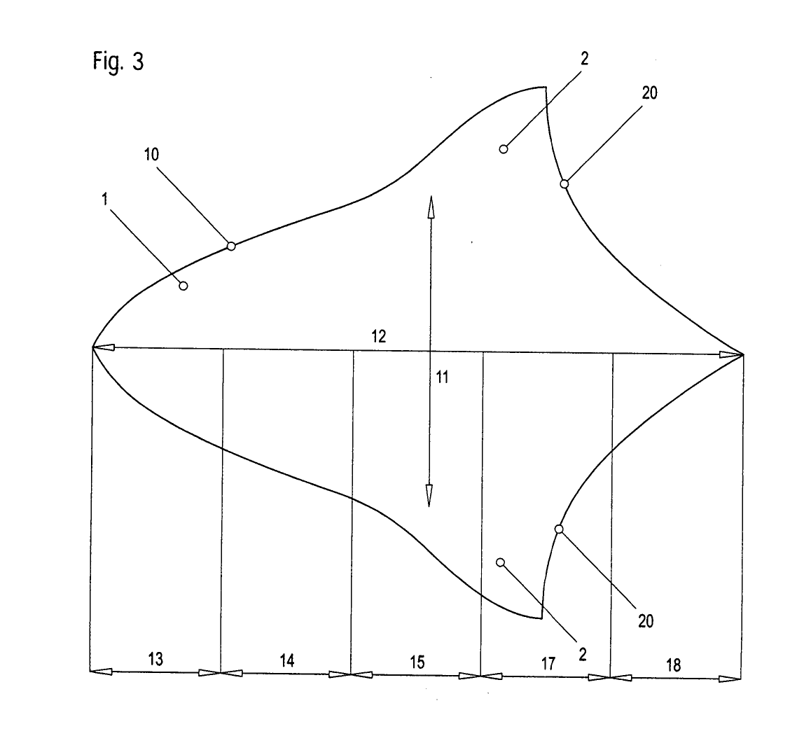

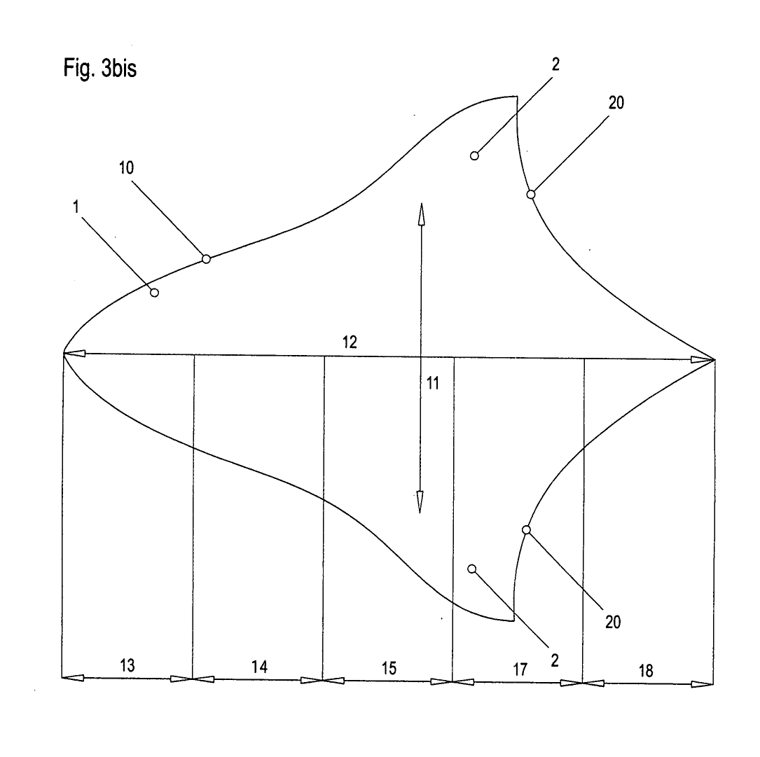

FIG. 3 shows the fuselage with seamlessly integrated wings.

FIG. 3bis shows the fuselage with seamlessly integrated wings in an alternative embodiment.

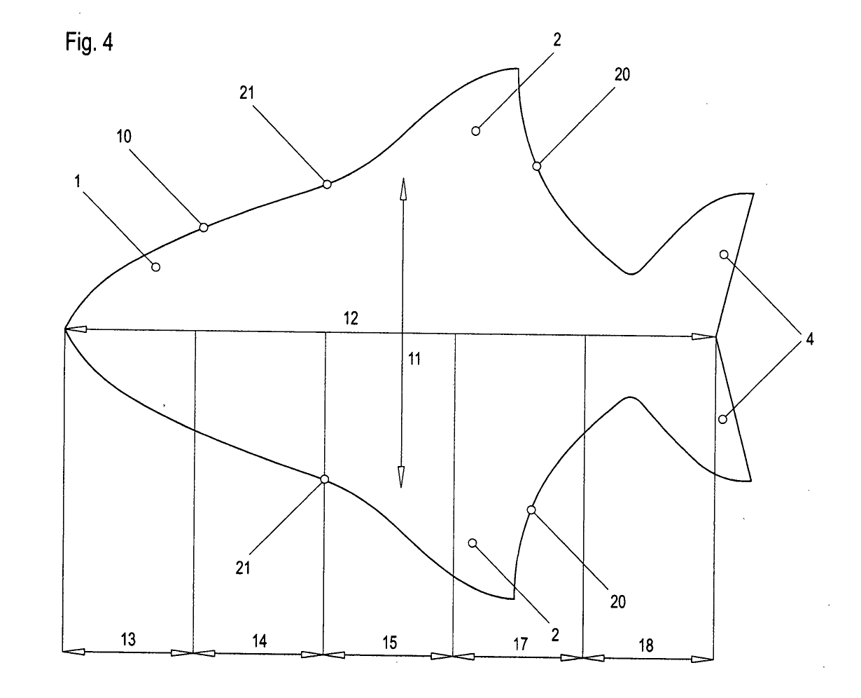

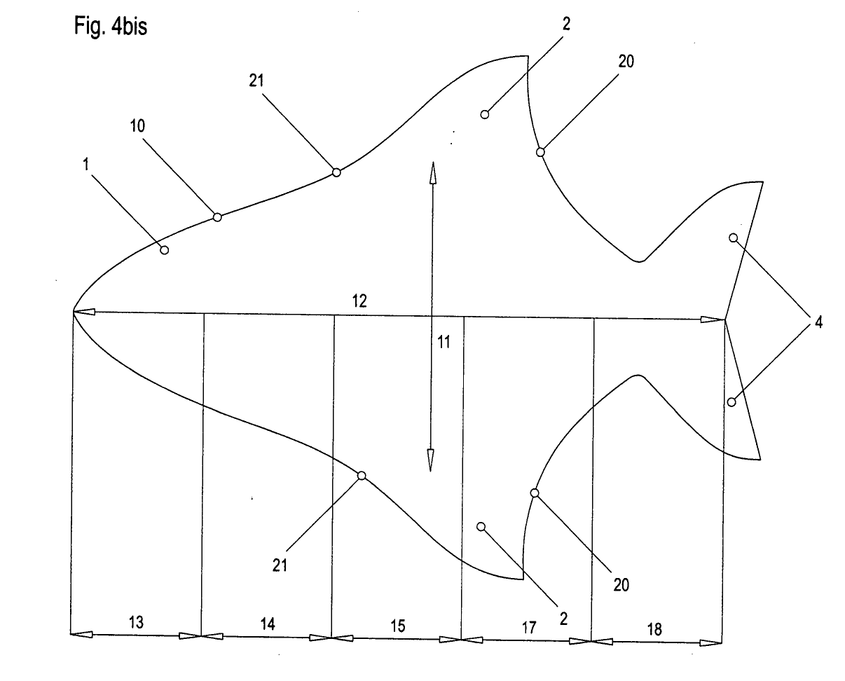

FIG. 4 shows the fuselage with seamlessly integrated wings and with a horizontal stabilizer.

FIG. 4bis shows the fuselage with seamlessly integrated wings and with a horizontal stabilizer in an alternative embodiment

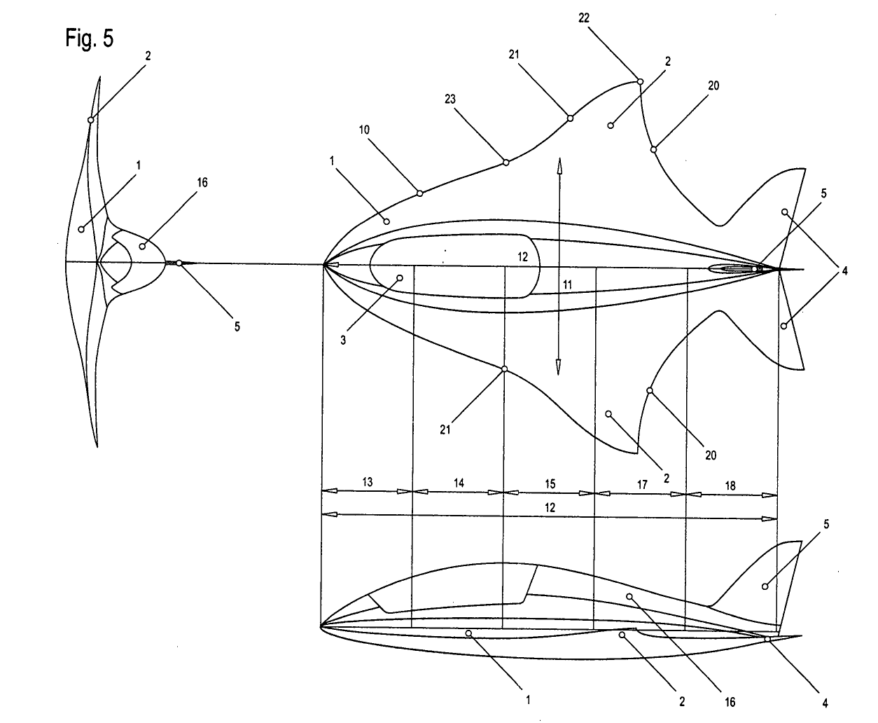

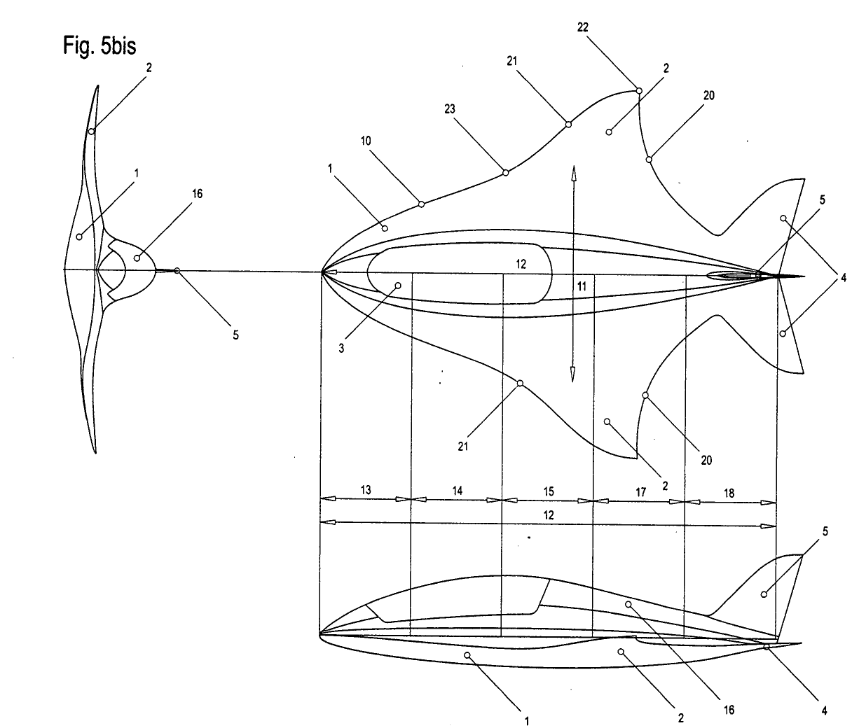

FIG. 5 shows three different views of the whole flight device with the fuselage, with the seamlessly integrated wings and with a seamlessly integrated horizontal stabilizer.

FIG. 5bis shows three different views of the whole flight device of the alternative embodiment with the fuselage, with the seamlessly integrated wings and with a seamlessly integrated horizontal stabilizer.

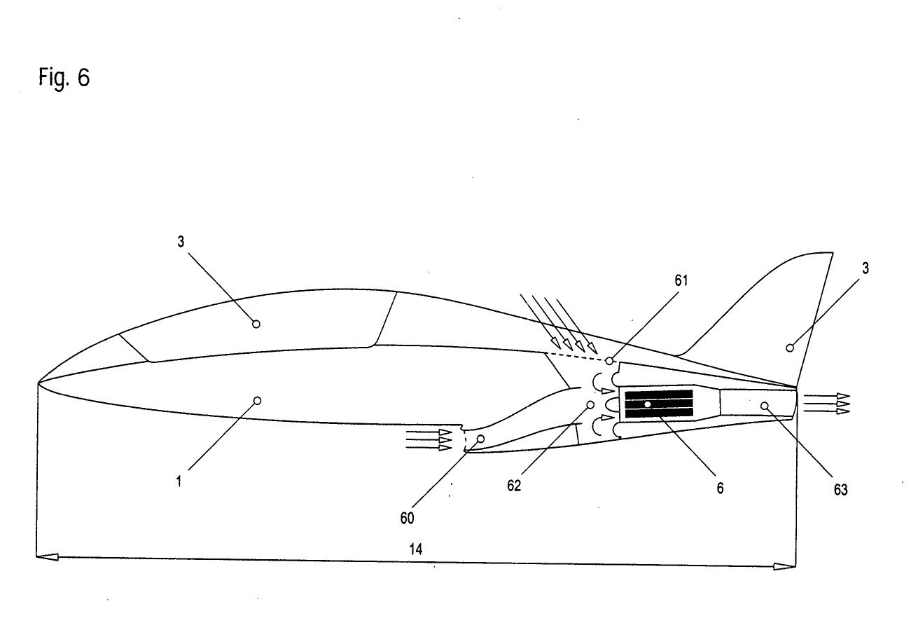

FIG. 6 shows a side view of the flight device.

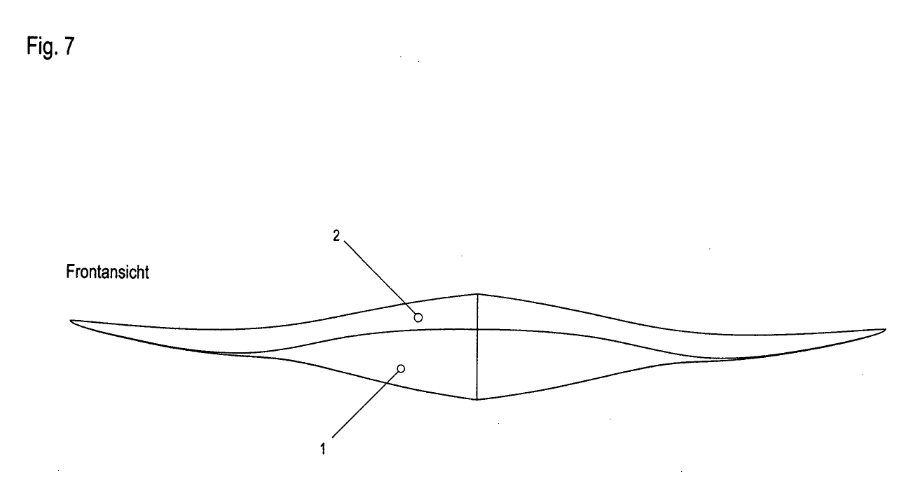

FIG. 7 shows a front view of the flight device.

FIG. 6 shows the longitudinal, negatively cambered profile of the fuselage.

FIG. 7 shows the longitudinal, positively cambered profile of the wings.

An elliptical lift distribution is the most efficient way of generating lift with a level wing. Wings with a small aspect ratio have nearly elliptical lift distributions for a large area of tapering and sweep. Wings with a great aspect ratio are in this respect much trickier and it does not require much for the lift distribution to change with another tapering of the wing or a not entirely correct decalage of the wing.

The drag of streamflown bodies is smallest when the stream can flow three-dimensionally around the body.

From the starting point of these reflections, it is thus advantageous if the lift surface is designed in such a way that it is streamflown three-dimensionally.

It is thus advantageous if the outline of the lift surface has an aerodynamic profile. In this manner, the stream flows not only over and under the lift surface but also sideways around the lift surface. FIG. 1 shows an example of the outline of a fuselage serving as lift surface and designed according to this principle. FIG. 1bis shows a further embodiment.

In this case, the outline of the fuselage corresponds to a symmetrical profile whose thickness (span) corresponds to 50% of the length. A value between 30 and 60%, preferably between 40 and 50%, would appear advantageous here.

The outline and the sheer line of the described basic shape both have aerodynamic profiles, contrary to traditional flight devices where only the sheer line is aerodynamically advantageous.

With this outline, the drag is minimal. Because of the small aspect ratio, however, the induced drag is great. Where the side edges are approximately parallel, i.e. approximately at the point of the largest span 11, a small angle of incidence will generate pressure compensation. Air from the underside of the lift surface flows on the upper side of the lift surface. This effect occurs already before the largest span is reached. The larger the angle of incidence and thus the lift, the further in front the air starts to flow from the underside of the lift surface to the upper side of the lift surface. It is thus at this very place that a small wing 2 must be fastened. This will considerably reduce the induced drag. According to the invention, the lift surface of the fuselage and of the wings looks as is represented in FIGS. 2 and 2bis.

The wing's front edge 21 is strongly oriented forwards and has a shape that, from front to back, is first concave and then convex. Aerodynamic tests have shown that the flight properties are optimal when the angle of the tangent of said curves have, at the inflexion point 23 between the concave segment and the convex segment, an angle between 10° and 55°, preferably between 25 and 55%, relative to the flight device's longitudinal axis 12 and when this inflexion point 23 is located approximately in the middle of the wing's front edge.

On the other hand, the outlet edge 20 of the wings 2 on the wing tip 22 has a normal angle to the flight device's longitudinal axis 12. In a variant embodiment, this angle varies between 60° and 120°, preferably between 70° and 110°, preferably between 80° and 100°, relatively to the flight device's longitudinal axis 12. In this way, the tip vortexes are not drawn inwards.

In order to keep the interference drag as small as possible, the transition from the fuselage and the wings 2 is designed seamlessly (FIG. 3 resp. 3bis). It is thus impossible to tell where the fuselage 1 stops and the wings 2 start. In this manner, the causes for interference drag are widely avoided. The fuselage and the wings can be designed as a unit.

The best flying performance (in the sense of maximal glide angle) of aircrafts with small aspect ratio are achieved with small lift correction values. Consequently, the moment correction values must also be very small, otherwise the trim drag becomes too great.

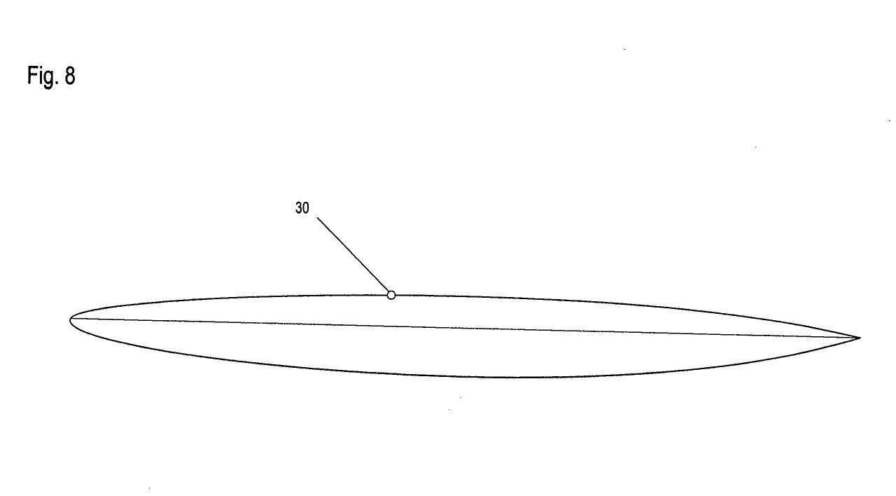

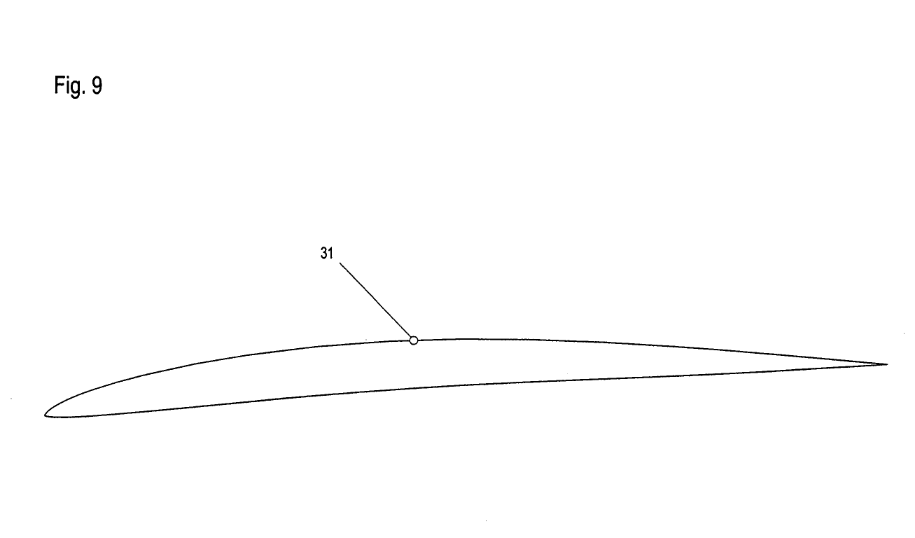

According to the invention, this is solved in that the longitudinal middle profile is approximately symmetrical. This is achieved for example by the longitudinal profile of the flight device having no or only a negative cambering (FIG. 8). The longitudinal profile of the wings can be slightly positively cambered (FIG. 9).

The profiles of the fuselage and of the wings have a different angle of attack. The profile of the wings and the profile of the fuselage are designed in such a way that both, when the flight device is at a certain angle of incidence, generate no lift. This is achieved in that the profile of the wing is set at an angle of incidence smaller by a couple of degrees than the profile of the fuselage.

Preferably, the longitudinal dihedral between the wings' profile and the fuselage's profile corresponds approximately to the sum of the angles of attack. In a variant embodiment, the longitudinal dihedral between the wings' profile and the fuselage's profile corresponds approximately to the difference of the angles of attack.

In a variant embodiment, the wings also have a symmetrical profile, but have a smaller angle of incidence than the fuselage.

The transition from the symmetrical or negatively cambered profile of the fuselage (with positive moment correction value) to the positively cambered profile of the wings (with negative moment correction value) is fluid.

The adjustment between the small angle of incidence of the wings and the greater angle of incidence of the fuselage is also progressive.

Through use of profiles with no or only very small cambering, the trim drag can be kept low.

With this measure, it is also possible to achieve that the lift surface, formed by the wings and the fuselage, has a very small moment correction value over a large speed range. This in its turn leads to only small trim forces and accordingly to good flying performances.

A further advantage of this measure is the improvement of the flight performances and flight properties during slow flight. This is because the induced angle of incidence of the wings, through the 3-D streamflow of the fuselage, is greater than the angle of incidence of the fuselage. In order then to prevent resp. delay a premature airflow breakaway at the wings, it is advantageous when the front edge in this area is pulled downwards, i.e. a profile with positive cambering is used for the wings, and when additionally the angle of incidence of the wings is chosen to be smaller than the angle of incidence of the fuselage.

This adjustment does not influence the pressure distribution negatively since, with wings with small aspect ratio, the lift distribution over a large area of twists and outlines is largely elliptical.

In order to be able to steer the flight device, an empennage 4 is necessary. The lever arm must be long enough so that with small steering forces, a sufficiently great moment can be generated. A longer lever arm furthermore has the advantage that the trim drag can be reduced. In order to ensure this, it is advantageous for the empennage 4 to be placed as far backwards on the fuselage as possible, as represented in FIG. 4.

In order to avoid interference drag, a fluid transition from the fuselage to the empennage is striven at. The flight device then looks as represented in FIG. 5 or 5bis.

It is impossible to clearly define where the fuselage 1 stops and where the horizontal stabilizer 4 starts. If the span of the horizontal stabilizer is chosen large enough, it is even possible for the horizontal stabilizer 4 to take on the function of the aileron.

The cockpit 1 can be partially integrated in the fuselage 1. It is advantageous for the cockpit 1 and the fuselage to have approximately the same length and for the transition between cockpit and fuselage to be designed fluidly, as represented in FIG. 5:

The pressure distribution on fuselage and wings is practically identical for the same wing/fuselage depth. The variation is only small. This means that there is only little or no interference drag.

A lift distribution that is as flat as possible, i.e. a lift correction value that remains as constant as possible for the whole lift surface, has the added advantage that in this manner bumps/shock waves occur only at higher speeds than with a lift surface that has an irregular lift distribution and thus areas with a high lift correction value.

The inventive design has some aerodynamic advantages:

A shape with a strong sweep of the front edge gives rise to a high Mach number (critical velocity ratio). This means that the traveling speed is close to sonic speed, so that in comparison with conventional flight devices with wings of large aspect ratio, the traveling speed is increased and thus the travel time is reduced. Through the particular shape of the lift surface and the fluid transitions on the whole flight device, the drag (with the exception of the induced drag) will be smaller than for conventional flight devices.

Because of the strong sweep of the front edge, at high incidence angles such as typically occur during take-off and landing, vortexes develop on the upper side of the lift surface, in the same way as for a delta wing. These vortexes generate additional lift, so that it is possible for a flight device according to the invention to forgo additional lift aids such as landing flaps. This is further aided by the relatively small wing loading, which allows moderate take-off and landing speeds even with small lift correction values.

In the case of delta wings, these vortexes can burst under certain conditions (Vortex Burst), so that the lift at this place is suddenly reduced. The roll/yaw movement (departure) resulting from asymmetrical vortex bursts with delta wings is a problem, especially for approval.

The shape of the inventive flight device allows this problem to be solved in that the place where vortexes burst is defined through the shape of the front edge and stabilized symmetrically. The sweep of the front edge first increases with increasing span. This fosters the development of a vortex. From a certain point of the span onwards, the sweep of the span is again smaller. The vortex bursts where the sweep of the front edge becomes smaller again, possibly somewhat further back.

Through the geometry of the front edge, the vortex burst is thus stabilized.

The slow flight properties are influenced considerably by the vortexes. The larger the angle of incidence, the stronger the development of vortexes on the upper side of the lift surface. The inventive flight device thus has advantageous slow flight properties.

A disadvantage however can be the high angle of incidence during taking off and landing., which is higher than for conventional aircrafts. The landing gear consequently is longer, which results in more weight and air drag. This disadvantage can be minimized by designing the lift surface so that the aerodynamic center/the center of pressure and the thus also the center of gravity come to lie relatively far behind. This can for example be achieved in that the point of the maximum span of the wings is located at 60% to 80%, preferably 66.66 to 80%, of the fuselage length. The landing gear can thus be placed further behind and designed accordingly shorter.

Since the horizontal stabilizer, when designed accordingly, can also be used as aileron, it is not necessary to fasten an aileron on the fuselage or the wings. This allows a construction with only very few mobile parts (steering surfaces).

Thanks to the long lever arm, only small forces on the horizontal stabilizer are necessary for compensating the moments. The descending forces on the horizontal stabilizer when the lift surfaces have been designed accordingly (profile with little or even no cambering, or with a negative cambering for the fuselage's profile and a positively cambered profile for the wings with smaller angle of incidence than the profile of the fuselage) are relatively small, which results in a low trim drag. Such a construction also requires no artificial stabilizing.

Because of the large lift surface, there is a small Ca-lift correction value and thus soft and small pressure changes. In this manner, an at least partially laminar boundary layer can be achieved so that the drag is reduced. This is achieved through the absence of a front fuselage and the fluid front edge. The left and the right front edges 10 from the tip of the flight device up to the widest span build each a continuous line with two inflexion points. Furthermore, both the transversal cross section surface as well as the transversal outline from the tip of the flight device to the widest span are fluid and continuous. In this way, there are no disturbances as for a conventional aircraft, where the boundary layer of the fuselage can cause disturbances at the boundary layer of the bearing wing and the boundary layer switches from laminar to turbulent, so that the drag is increased by this.

It is furthermore advantageous when the greatest thickness of the profiles of the fuselage and of the wing is situated relatively far back. This also fosters the at least partially laminar behavior, especially in the front area, thanks to the backwards shifting of the pressure minimum.

A further advantage of the present invention is that the volume increases steadily up to approximately the middle of the flight device's length. This leads to a thin boundary layer, which itself is advantageous for generating low air resistance.

The small wing loading, together with the regular pressure distribution, leads to a small minimum Cp on the fuselage. This itself enables high speeds in the transonic area without bumps occurring. This effect can further be improved by using so-called super-critical profiles that have been specially developed for high-speed cruising flights.

A further advantage of the present invention are the possibilities arising from the large volume regarding the installation of the powering unit. If a single fixed engine intake is arranged per powering unit, a thrust loss would arise during take-off and climbing flight, during cruising flight on the other hand drag would occur since part of the air must flow outside around the engine intake.

This problem is solved according to the invention in that the powering unit or units 6 are integrated within the fuselage 1, as can be seen in FIG. 6. This is possible thanks to the large internal volume resulting from the overall concept.

The integration of the powering units 6 in the fuselage allows secondary air inlets 61 on the fuselage's upper side (upper side of the lift surface). Thanks to these upper air inlets, the thrust during take-off, climbing flight, or when a maximal output power is required, can be maximized. During cruising flight, the upper secondary air inlets 61 on the fuselage's upper side are closed, so that only smaller air inlets 60 arranged on the fuselage's underside (lift surface) are used. In this manner, the overall operating efficiency of the propulsion system is increased, since on the one hand the boundary layer on the underside of the lift surface is thinner, and since on the other hand the local blower stream Mach number on the underside is considerably smaller than on the upper side.

The secondary air inlets 61 are preferably integrated running in the same direction within the profile of the upper side; when closed, they build a nearly even outer surface on the upper side of the fuselage. In order for them to automatically shut during cruising flight, they are preferably provided with self-actuated check flaps or valves (not represented). As soon as the pressure on the outer surface of the check flaps 62 is smaller than the pressure on the inside, for example during cruising flight, these flaps shut. During take-off, however, the valves are automatically opened through the under-pressure, so that more air arrives in the powering unit and a maximal thrust is achieved.

The air streams from the upper and the lower engine intakes are brought together concentrically in an airbox 62 integrated in the fuselage. The air flow from the intake or intakes 60 on the underside is lead into the center of the airbox, whilst the air flow from the upper secondary intakes 61 are lead inwards over an annular slit or annular surface 64. The back edge of this annular slit 64 is provided with a lip with a large radius. This intake lip is necessary in order to prevent an airflow breakaway at the powering unit intake.

In a variant embodiment, the lower intake 60 is shut during take-off, in order that no dirt is aspirated into the powering unit. This intake can for example remain shut as long as the landing gear is lowered.

Through this construction of the airbox 62 with the annular slit 64 and the annular surface, a more regular distribution of the speed of the air flowing into the powering unit 6 is achieved. As a variant or additionally, it would also be possible to use a perforated plate and/or a annular slit in the airbox.

The gas exhaust 63 of the powering unit or units is situated at the end of the fuselage 1 and has preferably a circular or approximately circular cross section. In the case of two powering units, each of the exhausts has a half-circular cross section, so that the exhaust cross section on the whole is again circular.

A further advantage of the construction is the fact that a spar (not represented) can be provided behind the cockpit 3. In conventional aircraft designs, this is a problem. There, a reinforcing spar is placed under the fuselage, but leads to an additional air resistance.

The inventive flight device has the following further advantages:

Structure

low bending stress of the cell

low weight of the structure

long lever arm of the empennage

small steering surfaces are sufficient

Security

no artificial stabilizing necessary

no airflow breakaway as for conventional flight devices

surface relatively insensitive to changes, flight security also warranted with ice build-up

the wing structure does not have to transmit landing shocks, since these are forwarded directly from the landing gear into the fuselage frame

Maintenance/Operating

thanks to small number of parts, only low maintenance expenditure

no artificial stabilizing necessary, no sophisticated electronics

thanks to the compact construction, low hangar space requirements

Noise Emissions/Environmental Concerns

no landing flaps, so that the noise generated during take-off and landing is not loud

the engine intakes 61 during take-off and climbing flight are placed on the wings' upper side. The powering units thus emit less noise downwards in this noise-critical phase than conventional powering unit installations.

the fuel can be distributed better, thus the trim drag can be kept as low as possible through pump-over of fuel or sequential emptying

a large reserve of fuel can be carried along without drag-generating additional tanks being necessary

the wing has a high flutter safety thanks to the rigidity arising from geometrical reasons, lower structure mass and preferably omission of the aileron. Nearly no bending moments arise with this construction. In this manner, the cell weight can be kept very low.

Thanks to the low structural weight, the proportion of freight in the overall weight will be considerably higher than for conventional aircrafts. Thus, the fuel consumption per kilogram of transported freight will be lower than for traditional aircrafts.

Crash Security of Flight Devices

In the inventive flight device, a large proportion of the structure's weight can be from the fuselage. The latter can thus be built in a more stable manner than for conventional flight devices, which increases the passengers' security in the case of light accidents.

Since the lift surface has only a small span and furthermore a considerably greater overall height than the wings of a conventional flight device, the forces and moments exerted on the structure are smaller than for conventional flight devices. The powering units 6 are located in the voluminous lifting body, and are not borne by the wings 2 or by slim pylons.

Due to the lower take-off and landing speeds, the danger for the passengers in the case of a crash landing is lower. The fuel is carried far away from the collaring points for landing gear and powering units. Unlike in many conventional multi-engine flight devices, the powering units are not located under the fuel-filled wings.

In comparison with pure all-wing type aircraft, the inventive construction has the advantage that the aerodynamic characteristics of the flight device such as longitudinal stability and control, lateral stability and control are improved. The fuselage's volume is clearly greater without the aerodynamic efficiency being impaired. The allowed area for the center of gravity is clearly wider.

The design of the invention has the further advantage that it can take on more volume than a conventional cylindrical fuselage, which means that the space available per passenger is greater or that bulky loads can be transported. There is more space available for installing the equipment, which improves the accessibility for maintenance purposes.

The total volume V available in the inventive flight device for the structure, systems, passenger space, freight space, cockpit, landing gear, tanks etc. has the following ratio to the length L (12) and to the maximal span I of the flight device including wings:

$$V = \frac{L \cdot l \cdot \sqrt{L \cdot l}}{k}$$

where the factor k lies between 10 and 60, typically around 30.

Thus, with the same powering performance as compared with a classical flight device, a greater useful volume can be transported faster.

Furthermore, the flight device preferably has an aspect ratio of λ<3 (λ=I²/S, where I represents the wing span and S the lift surface).

It is possible to construct a flight device with a smaller aspect ratio that consists of a combination of most of the previously described characteristics. Thus, by means of shaping the lift surfaces, the drag and induced drag can be reduced and the horizontal stabilizer can additionally be arranged in such a way that the drag can be reduced even further. By means of the integration of the powering unit or units in the fuselage, an optimal efficiency for the combination engine intake/powering unit can be achieved. Such a flight device will require much less power during cruising flight, since on the one hand the weight is small thanks to the compact construction and, on the other hand, the air resistance thanks to the previously described measures is very low. Furthermore, such a flight device is very easily built, no landing flaps or similar are necessary, merely aileron, horizontal stabilizer and vertical rudder for steering. A sports aircraft could for example be propelled by a turbine on the tail. In this manner, the streamflowing of the fuselage is only minimally disturbed.

Many different combinations of the described characteristics are of course conceivable.

The claimed flight device can be large enough to transport passengers and/or freight, but can also be built as model flight device, unmanned flight device, drone etc.

1. A flight device with:
a lift-generating fuselage, whose widest span lies in the first fifth and in the last fifth tapers progressively,
two wings, a projection area of both wings on a horizontal plane representing less than forty percent of the total lift surface,
a horizontal stabilizer on the rear fifth of the fuselage,
a longitudinal middle profile of the flight device having no or a negative cambering, and,
a longitudinal profile of the wings being positively cambered.

2. The flight device of claim 1, wherein the longitudinal middle profile of the flight device has an at least partially negative cambering.

3. The flight device of claim 2, wherein the largest span of said lift-generating fuselage lies in a third or a fourth fifth of the total length, and wherein the maximum span of the wings lies in the fourth fifth of the total length of said fuselage.

4. The flight device according to claim 3, whose largest span is located between 40% and 80% of the total length of said fuselage.

5. The flight device according to claim 4, whose largest span lies between 66% and 80% of the total length of said fuselage.

6. The flight device according to claim 1, wherein a profile of the fuselage has a positive moment correction value, and a profile of the two wings has a negative moment correction value.

7. The flight device according to claim 1, wherein the projection area of both wings on a horizontal plane represents less than thirty percent of the total lift surface.

8. The flight device according to claim 1, wherein the projection area of both wings on a horizontal plane represents less than twenty percent of the total lift surface.

9. The flight device according to claim 1, wherein the projection area of both wings on a vertical plane represents less than 60 percent of the projection area of both wings on a horizontal plane.

10. The flight device according to claim 1, wherein a span of said horizontal stabilizer has at least 90% of the widest span of the fuselage.

11. The flight device according to claim 1, wherein a ratio between the lift surface of a third and fourth fifth of the flight device including the wings and the lift surface of the first fifth and a second fifth of the flight device is between 1.5 and 3.0,
and wherein the ratio between the lift surface of said third and fourth fifth of the flight device including the wings and the lift surface of the last fifth of the fuselage is between 5.0 and 15.

12. The flight device according to claim 1, with a cockpit that is located in a thickening of the fuselage's upper side, said thickening being as long as said fuselage.

13. The flight device according to claim 12, wherein said cockpit is partially integrated in said fuselage.

14. The flight device according to claim 1, wherein the flight device has fluid transitions, so that it is not exactly discernible where said fuselage stops and where said wings start.

15. The flight device according to claim 1, wherein an outlet edge of said wings on a wing tip has an angle between 60° and 120° to a longitudinal axis of the flight device.

16. The flight device according to claim 15, wherein the outlet edge of said wings on the wing tip has an angle between 70° and 110° to the flight device's longitudinal axis.

17. The flight device according to claim 16, wherein the outlet edge of said wings on the wing tip has an angle between 80° and 100° to the flight device's longitudinal axis.

18. The flight device according to claim 17, wherein the outlet edges of said wings on the wing tip have an angle of 90° to the flight device's longitudinal axis.

19. The flight device according to claim 1, wherein a front edge of said wings has a shape that, from front to back, is first a concave curve and then a convex curve, and wherein an angle of the tangent of said concave and convex curves, at an inflexion point 23 between the concave segment and the convex segment, has an angle between 10° and 55° relative to a longitudinal axis of the flight device.

20. The flight device according to claim 1, wherein the wings have a smaller angle of incidence than the lift-generating fuselage.

21. The flight device according to claim 1, wherein steering around a longitudinal axis of the flight device occurs only through swinging in an opposite direction of said horizontal stabilizer.

22. The flight device according to claim 1, wherein a left and the right front edges from the a tip of the flight device up to said widest span from front to back has first a convex, then a concave and then again a convex shape.

23. The flight device according to one of the claim 1, having an aspect ratio of λ<3 [[(]] wherein λ=ι²/S, and ι represents a span of the wings and S represents lift surface[[)]].

24. The flight device according to claim 1, wherein a ratio between a length and a maximal span of the flight device including wings is between 0.5 and 1.5.

25. The flight device according to claim 1, wherein a ratio between a length and the a maximal span of the flight device including wings is between 0.75 and 1.5.

26. The flight device according to claim 1, further comprising at least one powering unit that is at least partially integrated in the fuselage.

27. The flight device according to claim 26, further comprising at least one powering unit engine intake on an underside of the flight device.

28. The flight device according to claim 26, further comprising at least one additional powering unit engine intake on an upper side of the flight device.

29. The flight device according to claim 27, wherein said additional powering unit engine intake can be opened independently of the powering unit engine intake on the underside of the flight device during take-off and/or climbing flight.

30. The flight device according to claim 28, wherein said additional powering unit engine intake builds a nearly even outer surface on an upper side of the fuselage.

31. The flight device according to claim 26, further comprising at least one powering unit engine intake on an upper side of the flight device.

32. The flight device according to claim 1, having an analogy to the shape of a fish.

33. The flight device according to claim 1, wherein a left and right front edges from a tip of the flight device up to said widest span build a fluid, continuous line with two inflexion points.

34. The flight device according to claim 1, wherein a transversal cross section surface from a tip of the flight device to said widest span is fluid and continuous.

35. The flight device according to claim 1, wherein a transversal outline from a tip of the flight device to said widest span are fluid and continuous.

36. The flight device according to claim 1, wherein a left and the right outer profile from a tip of the flight device up to the widest span build a fluid, continuous line with two inflexion points.

37. The flight device according to claim 1, wherein a transversal cross section surface and/or a transversal outline from a tip of the flight device to said widest span are fluid and continuous.

38. The flight device according to claim 1, wherein a profile of one of said wing has a smaller angle of incidence than the a profile of the fuselage.

39. The flight device according to claim 1, wherein a negatively cambered profile in flight has a wider angle of incidence than a positively cambered profile or profiles.

40. A flight device with:
a lift-generating fuselage, whose outline tapers progressively in the first fifth and in the last fifth,
two wings, the projection area of both wings on a horizontal plane representing less than forty percent of the total lift surface,
a horizontal stabilizer on the rear fifth of the fuselage,
the fuselage's profile having a positive moment correction value whilst the wings' profile has a negative moment correction value.
